(19) United States
(12) Patent Application Publication
(10) Pub. No.: US 2012/0319326 A1
(43) Pub. Date: Dec. 20, 2012

(54) FINE STRUCTURE TRANSFER APPARATUS AND FINE STRUCTURE TRANSFER METHOD

(75) Inventors: Toshimitsu Shiraishi, Kamisato (JP); Kyoichi Mori, Kamisato (JP); Noritake Shizawa, Kamisato (JP); Naoaki Yamashita, Kamisato (JP); Masahiko Ogino, Hitachi (JP); Akihiro Miyauchi, Hitachi (JP)

(73) Assignee: HITACHI HIGH-TECHNOLOGIES CORPORATION, Tokyo (JP)

(21) Appl. No.: 13/577,337

(22) PCT Filed: Mar. 10, 2011
(86) PCT No.: PCT/JP2011/055690

§ 371 Date: Aug. 6, 2012

(30) Foreign Application Priority Data
Mar. 11, 2010 (JP) 2010-054209

(51) Int. Cl. B29C 59/02

(52) U.S. Cl. 264/293; 425/385

(57) ABSTRACT

The fine structure transfer apparatus is provided with a pattern transfer mechanism having a resin applying mechanism, a substrate handling mechanism, an aligning mechanism, a pressurizing mechanism, and a peeling mechanism, and the pressurizing mechanism is configured of an upper head section and a lower stage section, the molding die having the fine pattern formed thereon is fixed on the lower surface of the upper head section, and after pressurization and transfer, the lower stage section retracts from a position below the substrate in the state wherein the substrate is adhered to the molding die, then, after the peeling mechanism is moved to a position below the substrate, the substrate adhered to the molding die is peeled.

### TECHNICAL FIELD

The present invention relates to a fine structure transfer apparatus and a fine structure transfer method. In more detail, the present invention relates to a fine structure transfer apparatus and a fine structure transfer method for pressing a molding die with a fine pattern on the surface onto a transfer target object and forming the fine pattern on the surface of the transfer target object.

### BACKGROUND ART

Recently, semiconductor integrated circuits are being reduced in size and integrated, and as a pattern transfer technology for implementing the fine machining, precision of photolithography apparatuses has been increased. However, the machining method reached the wavelength of light of exposure and the lithography technology also reached the limit. Accordingly, in order to newly reduce the size and increase the precision, an electron-beam printing apparatus that is a kind of a charged particle ray apparatus has been used, instead of the lithographic technology.

There is a defect that the pattern shape using an electron beam, unlike the collective exposing method when forming a pattern using light such as an i-ray and an excimer laser, takes a long time for exposing (printing), as there are patterns to print, to take the method of printing a mask pattern, and it takes time to form a pattern. Accordingly, as the capacity of memories and the integrity are greatly increased, such as 256 Mb, 1 Gb, and 4 Gb, the density of a pattern increases, and accordingly, it may take more time to form the pattern and the throughput may be remarkably decreased. Therefore, in order to increase the speed of the electron-beam printing apparatus, a collective figure irradiation method that combines various shapes of masks and forms an electron beam having a complicate shape by collectively radiating an electron beam to the masks has been developed. As a result, the size of the pattern is reduced, and the electron-beam printing apparatus is necessarily increased in size and complicated, thereby increasing the price of the apparatus.

Accordingly, technologies for forming a fine pattern at a low cost are disclosed in Patent Literature 1 and 2 and Non-Patent Literature 1. The technologies are to transfer a predetermined pattern by embossing a resin film layer formed on the surface of a transfer target substrate with a molding die with prominences and depressions of a pattern which is the same as a pattern to form on a substrate, and particularly, according to the nano-imprint technology described in Patent Literature 2 or Non-Patent Literature 1, a silicon wafer is used as a molding die and a fine structure of 25 nanometer or less can be formed by transferring.

Further, a technology about an imprint method and apparatus includes aligning, pressing, UV-radiating, and releasing, and carrying, which is provided between the units and carries a molding die and a substrate in a pair between units, is disclosed in Patent Literature 3 and Patent Literature 4.

### CITATION LIST

### Patent Literature

Patent Literature 1: U.S. Pat. No. 5,259,926
Patent Literature 2: U.S. Pat. No. 5,772,905
Patent Literature 3: Japanese Patent Application Laid-Open Publication No. 2009-265187
Patent Literature 4: Japanese Patent Application Laid-Open Publication No. 2009-262350

### Non Patent Literature

Non-Patent Literature 1: S. Y. Chou et al., Appl. Phys. Lett., Vol. 67, p. 3314 (1995)

### SUMMARY OF INVENTION

### Technical Problem

A fine structure is formed on a substrate surface through a plurality of processes of resin applying, aligning, pressurizing, and separating which are performed on the substrate by nano-imprint. Therefore, in order to improve productivity of the machining for forming a fine structure, it is necessary to reduce the time for the processes and the time for moving between the processes.

Further, the machining is generally performed in a clean room in the nano-imprint because fine foreign substances cause defects. Accordingly, the smaller the footprint area of the apparatus, the more the number of apparatuses that can be installed in one clean room can be increased, and productivity for one clean room is also improved. However, when the imprint methods described in Patent Literature 3 and 4 are used, carrying is necessary between all the units to carry a molding die and a substrate and a space for the carrying is necessary, such that the entire footprint area of the apparatus increases and it takes time to attach/detach the substrate in the carrying, thereby interfering with improving productivity in the machining for forming a fine structure.

According to the situations, it is an object of the present invention to implement an apparatus with a small footprint area by reducing the time for moving the substrate between the processes and by reducing the space for carrying, and to improve productivity in machining for forming a fine structure.

### Solution to Problem

In order to address the above object, the present invention provides a fine structure transfer apparatus that forms a thin resin film on a substrate, cures the thin resin film with a molding die, which has a fine pattern formed thereon, pressed onto the thin resin film, and forms a fine pattern on the substrate, comprising a pattern transfer mechanism including a resin applying mechanism, a substrate handling mechanism, an aligning mechanism, a pressurizing mechanism, and a separating mechanism, in which the pressurizing mechanism is including an upper head section and a lower stage section, a molding die having a fine pattern is fixed to the lower surface of the upper head section, a lower stage section retracts from a lower portion of the substrate with the substrate in close contact with the molding die, after pressurizing and transferring, and then the separating mechanism is moved under the substrate and the substrate that is in close contact with the molding die is separated.

According to an aspect of the present invention, after resin is applied, and after the substrate is installed on the lower stage after being aligned on the lower stage section, and the lower stage is moved under the upper head. Therefore, the lower stage also functions as a carrying mechanism, such that a carrying mechanism for an aligning stage and a pressurizing stage is not necessary. Further, after the substrate is pressurized on a molding die by the pressurizing mechanism and the resin on the substrate is cured, the lower stage retracts from under the substrate with the substrate in close contact with the molding die, and then the separating mechanism is moved under the substrate and separates the substrate from the molding die and retracts from under the molding die, such that a carrying mechanism between the pressurizing mechanism and the separating mechanism can be removed, the footprint area of the apparatus can be reduced, and the time for attaching/detaching the substrate for carrying is reduced, thereby implementing an apparatus having high productivity. Further, by the configuration, it is possible to arrange the resin applying, substrate handling, aligning, pressurizing, and separating mechanisms in a straight line, and unnecessary spaces are removed, which contributes to reducing the footprint area.

Further, in order to address the above object, the fine structure transfer apparatus further includes a substrate loading mechanism for loading a substrate on the pattern transfer mechanism and a substrate unloading mechanism for unloading the pattern-transferred substrate, and the substrate loading mechanism, plurality of the pattern transfer mechanisms, and the substrate unloading mechanism are arranged such that the direction in which the substrate is moved by the substrate loading mechanism and the substrate unloading mechanism and the movement direction of the substrate in the pattern transfer mechanism go straight.

By this configuration, a pair of substrate loading mechanism and substrate unloading substrate can load and unload substrates for a plurality of pattern transfer mechanisms. Further, as the movement direction of the substrate in the substrate loading and unloading mechanisms and the movement direction of the substrate in the pattern transfer mechanism go straight, when a plurality of straight pattern transfer mechanisms are arranged, the apparatus can be arranged with a small dead space.

### Advantageous Effect of Invention

By using the fine structure transfer apparatus of the present invention, a substrate carrying mechanism for carrying a substrate from the aligning mechanism to the pressurizing mechanism and the separating mechanism is not necessary and the time for attaching/detaching a substrate for carrying is reduced. Further, a space occupied by the substrate carrying mechanism is not necessary, the resin applying, aligning, pressurizing, and separating mechanisms can be arranged in a straight line, and a plurality of straight-shaped pattern transfer mechanisms can be disposed between a pair of substrate loading mechanism and substrate unloading mechanism, such that it is possible to implement a fine structure transfer apparatus with a small footprint area. As a result, productivity of machining for forming a fine structure is improved.

### BRIEF DESCRIPTION OF DRAWINGS

FIG. 1 is a side view schematically showing the configuration of a pattern transfer mechanism in a fine structure transfer apparatus of the present invention.

FIG. 2 is a schematic view showing the upper surface arrangement of another exemplary configuration of a fine structure transfer apparatus of the present invention.

FIG. 3 is a partial cross-sectional view schematically showing another embodiment of a pattern transfer mechanism in a fine structure transfer apparatus of the present invention.

FIG. 4 is a partial cross-sectional view schematically showing another movement state of the pattern transfer mechanism shown in FIG. 3.

FIG. 5 is a cross-sectional view schematically showing a process of forming a fine structure on the disk substrate surface of a hard disk by the pattern transfer mechanism in the fine structure transfer apparatus of the present invention shown in FIG. 1.

FIG. 6 is a cross-sectional view schematically showing a process of forming a fine structure on the disk substrate surface of a hard disk by the pattern transfer mechanism in the fine structure transfer apparatus of the present invention shown in FIG. 1.

FIG. 7 is a cross-sectional view schematically showing a process of forming a fine structure on the disk substrate surface of a hard disk by the pattern transfer mechanism in the fine structure transfer apparatus of the present invention shown in FIG. 1.

FIG. 8 is a cross-sectional view schematically showing a process of forming a fine structure on the disk substrate surface of a hard disk by the pattern transfer mechanism in the fine structure transfer apparatus of the present invention shown in FIG. 1.

FIG. 9 is a cross-sectional view schematically showing a process of forming a fine structure on the disk substrate surface of a hard disk by the pattern transfer mechanism in the fine structure transfer apparatus of the present invention shown in FIG. 1.

FIG. 10 is a cross-sectional view schematically showing a process of forming a fine structure on the disk substrate surface of a hard disk by the pattern transfer mechanism in the fine structure transfer apparatus of the present invention shown in FIG. 1.

FIG. 11 is a cross-sectional view schematically showing a process of forming a fine structure on the disk substrate surface of a hard disk by the pattern transfer mechanism in the fine structure transfer apparatus of the present invention shown in FIG. 1.

FIG. 12 is a cross-sectional view schematically showing a process of forming a fine structure on the disk substrate surface of a hard disk by the pattern transfer mechanism in the fine structure transfer apparatus of the present invention shown in FIG. 1.

FIG. 13 is a cross-sectional view schematically showing a process of forming a fine structure on the disk substrate surface of a hard disk by the pattern transfer mechanism in the fine structure transfer apparatus of the present invention shown in FIG. 1.

FIG. 14 is a cross-sectional view schematically showing a process of forming a fine structure on the disk substrate surface of a hard disk by the pattern transfer mechanism in the fine structure transfer apparatus of the present invention shown in FIG. 1.

FIG. 15 is a partial cross-sectional view schematically showing an example of a fine structure transfer apparatus 22B provided with an automatic replacement function for a molding die 20-3.

FIG. 16 is a cross-sectional view schematically showing the first step of the work of replacing the molding die 20-3 in the fine structure transfer apparatus 22B shown in FIG. 15.

FIG. 17 is a cross-sectional view schematically showing the second step of the work of replacing the molding die 20-3 in the fine structure transfer apparatus 22B shown in FIG. 15.

FIG. 18 is a cross-sectional view schematically showing the third step of the work of replacing the molding die 20-3 in the fine structure transfer apparatus 22B shown in FIG. 15.

FIG. 19 is a cross-sectional view schematically showing the fourth step of the work of replacing the molding die 20-3 in the fine structure transfer apparatus 22B shown in FIG. 15.

FIG. 20 is a cross-sectional view schematically showing the fifth step of the work of replacing the molding die 20-3 in the fine structure transfer apparatus 22B shown in FIG. 15.

FIG. 21 is a cross-sectional view schematically showing the sixth step of the work of replacing the molding die 20-3 in the fine structure transfer apparatus 22B shown in FIG. 15.

FIG. 22 is a cross-sectional view schematically showing the seventh step of the work of replacing the molding die 20-3 in the fine structure transfer apparatus 22B shown in FIG. 15.

FIG. 23 is a partial cross-sectional view schematically showing another embodiment of a fine structure transfer apparatus of the present invention.

FIG. 24 is a partial cross-sectional view schematically showing a process of the work of replacing the molding die 20-3 in the fine structure transfer apparatus shown in FIG. 23.

FIG. 25 is a partial cross-sectional view showing a process of the work of replacing the molding die 20-3 in the fine structure transfer apparatus shown in FIG. 23.

FIG. 26 is a partial cross-sectional view schematically showing a process of the work of replacing the molding die 20-3 in the fine structure transfer apparatus shown in FIG. 23.

FIG. 27 is a partial cross-sectional view schematically showing a process of the work of replacing the molding die 20-3 in the fine structure transfer apparatus shown in FIG. 23.

### DESCRIPTION OF EMBODIMENTS

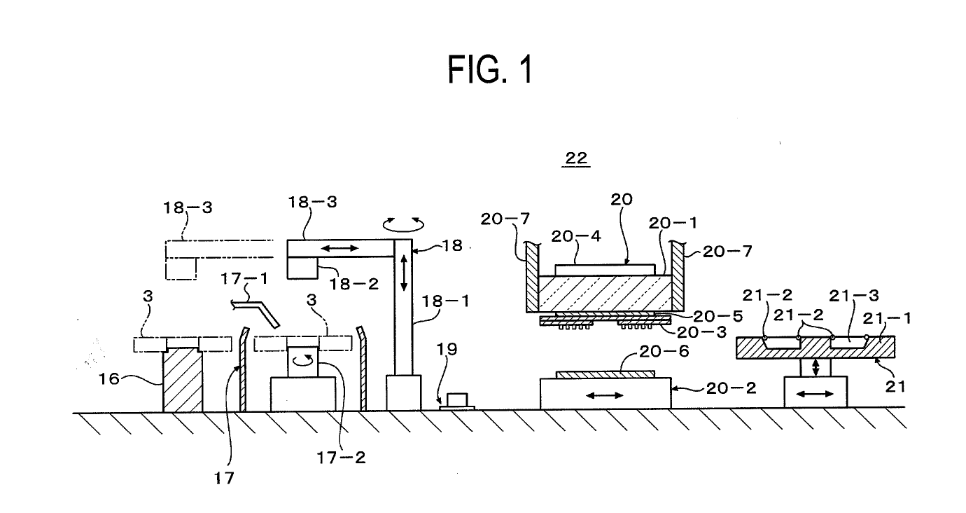

FIG. 1 is a side view schematically showing the configuration of an example of a pattern transfer mechanism in a fine structure transfer apparatus of the present invention. As shown in the figure, a fine structure transfer apparatus of the present invention includes a pattern transfer mechanism 22 composed of a resin applying mechanism 17, a substrate handling mechanism 18, an aligning mechanism 19, a pressurizing mechanism 20, and a separating mechanism 21. According to the pattern transfer mechanism 22 of the fine structure transfer apparatus of the present invention, processing is performed straight from the resin applying mechanism 17 to the separating mechanism 21.

The resin applying mechanism 17 of the present invention is not specifically limited as long as it can apply resin onto a substrate, and a dispense method, an inkjet method, a spray method, and a spin coat method are exemplified. In particular, the spin coat method is preferable because it can uniformly form a thin film throughout the entire surface of a substrate. In the spin coat method, it is preferable in controlling the thickness of the applied film that a spin coat apparatus is possible to control the timing of dropping resin, the dropping position, and the dropping amount, and it is also possible to control the time to reach a predetermined spin, in addition to the number of spins and a spin maintenance time.

In the drawings, reference numeral ‘17-1’ indicates a resin applying nozzle for spin coat and reference numeral ‘17-2’ indicates a spindle chuck for rotating a substrate. Reference numeral ‘3’ indicates a substrate.

The substrate 3 that is used in the present invention is not specifically limited as long as the surface is flat. As the material, a material having strength and machinability such as a silicon wafer, various metal materials, glass, quartz, ceramic, and plastic may be used. Further, common thin films such as a metal layer, a resin layer, and an oxide layer may be formed on the substrate surface, if necessary, in a multilayer structure. The shape is not specifically limited, but a circular plate shape is preferable because liquid-state resin can be applied by a spin coat method. Further, a circular substrate with a concentric circular hole at the center is included in the substrate of the present invention. Further, common thin films such as a metal layer, a resin layer, and an oxide layer may be formed on the substrate surface, if necessary, to form a multilayer structure.

If the liquid-state resin film is composed of a plurality of components having low reactivity and the viscosity in a room temperature, basically, it can be used in the present invention. In particular, a photo-curable material is preferable because curing time is reduced. Therefore, for example, a material obtained by adding a photosensitive substance into a synthetic resin material can be used. As the synthetic resin material, for example, substances of which the main component is cyclo olefin polymer, polymethyl methacrylate (PMMA), polystyrene polycarbonate, polyethylene terephthalate (PET), polyactic acid (PLA), polypropylene, polyethylene, polyvinyl alcohol (PVA) and the like may be used. The photo-curable material may be, for example, a peroxide, an azo compound-based material (for example, azobisisobutyronitrile), a kethone-based material (for example, benzoin and acetone), diazoamino benzene, metal-based complex salts, and dye. The liquid-state resin film is also called a resist film.

The substrate handling mechanism 18 of the present invention may be a common handling mechanism known in the art. As a method of holding a substrate, a method of mechanically holding an edge of the substrate or a method of absorption to the vacuum in the front surface or the rear surface of the substrate are exemplified. In the drawings, reference numeral ‘18-1’ indicates a vertical handling arm that can move up/down and rotate, reference numeral ‘18-2’ indicates a chuck head for absorbing the substrate to the vacuum, and reference numeral ‘18-3’ indicates an extendible horizontal handling arm. The extendible horizontal handling arm 18-3 holds the substrate 3, which is placed on a substrate load position 16, and transfers it above the resin applying mechanism 17 to the spindle chuck 17-2 of the resin applying mechanism 17.

The aligning mechanism 19 of the present invention is a mechanism for transferring a pattern to a specific position on a substrate, and in detail, it recognizes a relative position to an alignment pattern of a molding die, an alignment pattern on a substrate, or a specific section such as the substrate end, using an optical device such as a CCD, and then performs alignment by moving any one of the molding die or the substrate, using a predetermined algorithm. Further, when the shapes of substrates are the same, a mechanism that performs simply alignment by mechanically holding predetermined edges of the substrates may be used.

The pressurizing mechanism 20 of the present invention has a mechanism that attaches a molding die to a substrate where resin is applied, and cures the resin. The pressurizing mechanism 20 of the present invention has an upper head section 20-1 and a lower stage section 20-2 and the molding die 20-3 where a fine pattern to be transferred is formed is fixed to the upper head section 20-1. For example, the molding 20-3 can be detachably held by the pressurizing mechanism 20 by being absorbed to the vacuum to the lower surface of the upper head section 20-1 of the pressurizing mechanism 20. The upper head section 20 may be supported by a support arm 20-7, for example. Further, in pressurizing, any one of the upper head section 20-1 and the lower stage section 20-2 is moved up/down and the substrate and the molding die are pressurized. It is preferable to perform pressurizing by configuring the upper head section 20-1 to be movable up/down. In this case, the support arm 20-7 may be connected to an appropriate elevating mechanism (not shown).

As the thrust force for pressurizing, air pressure or oil pressure, other than a combination of a ball screw and a motor, may be used. The pressurizing thrust force of the pressurizing mechanism 20 of the present invention can be appropriately controlled and has thrust force of about 10 N to 1 KN. Further, as the control method, feedback control by a load cell is preferably exemplified. Further, the pressurizing speed and pressurizing-keeping time can be appropriately controlled. In addition, the lower stage section 20-2 of the pressurizing mechanism 20 of the present invention has a structure that can move in parallel with the substrate movement direction in the fine structure transfer apparatus 1. Furthermore, the upper head section 20-1 of the pressurizing mechanism 20 of the present invention includes a built-in UV-radiating mechanism 20-4 for curing resin. As another method, the UV-radiating mechanism 20-4 may be installed at the lower stage section 20-2.

The UV-radiating mechanism 20-4 is, in detail, exemplified by an extra high-pressure mercury lamp or an LED. In particular, the LED is preferable because it occupies a small space for installation in comparison to the extra high-pressure mercury lamp and does not include a heat line in radiated light. Further, a shock-absorbing layer 20-5 formed by a transparent elastic body may be installed between the upper head section 20-1 of the pressurizing mechanism 20 and the molding die 20-3 or a shock-absorbing layer 20-6 formed by an elastic body may be installed on the upper surface of the lower stage section 20-2. Using the shock-absorbing layers, as above, is preferable because it implements uniform pressurizing by absorbing curves of the substrate or the molding die. In addition, though not shown in the drawings, a parallelism adjusting mechanism for ensuring parallelism of the upper head section 20-1 and the lower stage section 20-2 may be installed in the pressurizing mechanism 20 of the present invention.

In the present invention, the molding die 20-3 has a fine pattern to transfer on the surface. And a method of forming the fine pattern on the molding die 20-3 is not specifically limited. For example, photolithography, electron-beam printing, and nano-imprinting are selected in accordance with the desired machining precision. As the material for a molding die, a material having strength and machinability with necessary precision such as a silicon wafer, various metal materials, glass, quartz, ceramic, and resin may be used. In detail, it is preferable to contain Si, SiC, SiN, polycrystalline Si, Ni, Cr, and Cu, a photo-curable resin material, and a material containing one or more of them. In particular, quartz is preferable because it has high transparency and allows light to be efficiently radiated to resin in photo-curing. Further, an elastically deformable resin material is preferable because it can minimize a defect area around foreign substances when there are foreign substances on the substrate surface. In particular, glass is preferable because it is possible to apply an elastically deformable resin material on a transparent substrate, using a nano-imprinting technology and to simply manufacture the molding die formed by transferring.

It is more preferable to perform release treatment for preventing bonding to the cured liquid-state resin film on the surface of the molding die. As the method of surface treatment, it is preferable that a fluorine compound is formed with a thickness of several nm on the surface, other than a silicon-based release agent, is formed.

The separating mechanism 21 of the present invention is for separating the substrate being in close contact with the molding die 20-3 from the molding die, after pressurizing by the pressurizing mechanism 20 and curing the resin. In separating, after the separating mechanism 21 moves under the substrate being in close contact with the molding die 20-3, any one of the separating mechanism 21 and the upper head section 20-1 vertically moves, the substrate and the separating mechanism are in contact and the substrate is fixed to the separating mechanism, and then any one of the upper head section 20-1 and the separating mechanism 20 vertically moves, thereby separating the substrate from the molding die. As the method of fixing the substrate in the separating mechanism 20, absorption to the vacuum or electrostatic absorbing is exemplified, other than the method of mechanically holding the edge of the substrate. Further, a method that does not damage the transferring section when fixing the substrate is preferable. In the embodiment shown in the figures, only the edge of the substrate is in contact with the separating chuck 21-1 of the separating mechanism 21, and an O-ring 21-2 and an absorbing cavity 21-3 for absorbing are formed.

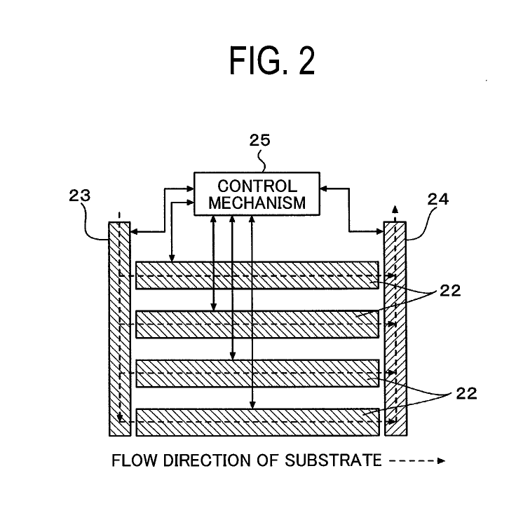

FIG. 2 is a schematic view showing the upper surface arrangement of another example of a fine structure transfer apparatus of the present invention. A plurality of (four in the figure) the pattern transfer mechanisms 22 composed of the resin applying mechanism 17, the substrate handling mechanism 18, the aligning mechanism 19, the pressurizing mechanism 20, and the separating mechanism 21, which is shown in FIG. 1, is arranged in parallel, and a substrate loading mechanism 23 and a substrate unloading mechanism 24 are further installed perpendicular to the arrangement line of the pattern transfer mechanisms 22. According to the embodiment, a substrate can be loaded and unloaded to the plurality of pattern transfer mechanism by the pair of substrate loading mechanism 23 and substrate unloading mechanism 24, and as the four pattern transfer mechanisms 22 transfer a pattern in any process, respectively, productivity is greatly improved, and as the straight pattern transfer mechanisms 22 are arranged in the perpendicular direction, a fine structure transfer apparatus with a reduced dead space, a reduced footprint area, and high productivity is implemented. It is preferable that the pattern transfer mechanisms are equipped with a control mechanism 25 for general control such that any one process of resin applying, substrate handling, aligning, pressurizing, and separating can be simultaneously performed on at least two substrates, in any one of the resin applying mechanism, the substrate handling mechanism, the aligning mechanism, the pressurizing mechanism, and the separating mechanism. The control mechanism 25 may be configured to be able to also control the pattern transfer mechanism 22, the substrate loading mechanism 23, and the substrate unloading mechanism 24.

The substrate loading mechanism 23 of the present invention takes out a substrate from a substrate case (not shown) in which a plurality of substrates are stored and carries the took out substrate to the substrate loading position 16 (see FIG. 1) of the pattern transfer mechanism 22. The substrate loading mechanism 23 may be equipped with a loader (not shown). A method of holding a substrate with the loader, a method of mechanically holding the edge of a substrate or a method of absorbing the rear surface of a substrate is exemplified. Further, it is preferable that the carrying direction of the substrate is straight for the substrate movement direction in the pattern transfer mechanism 22, for efficient arrangement of the apparatus. As the driving thrust force of the substrate loading mechanism, driving by a linear motor or driving by compressed air, other than driving by combination of a motor and a ball screw, is exemplified. Further, the substrate support section (unloader) of the substrate unloading mechanism 24 is connected to a driving mechanism through a robot arm and three-dimensionally operated. The substrate unloading mechanism 24 of the present invention is also a mechanism that returns substrates after separating from the separating mechanism and moves the substrate to a substrate return case (not shown) and the basic configuration is the same as that of the substrate loading mechanism 23.

The important point of the pattern transfer mechanism in the fine structure transfer apparatus of the present invention is that the lower stage section 20-2, which constitutes the pressurizing mechanism 22, and the separating mechanism 21 can move to change the position in accordance with the process of transferring. A movement-driving mechanism that allows the lower stage section 20-2 and the separating mechanism 21 to move may be a common means that is well known to those skilled in the art. Therefore, it is preferable to make the position of the upper head section 20-1, which constitutes the pressurizing mechanism 20, in constant. The lower stage section 20-2 and the separating mechanism 21 may move separately or integrally.

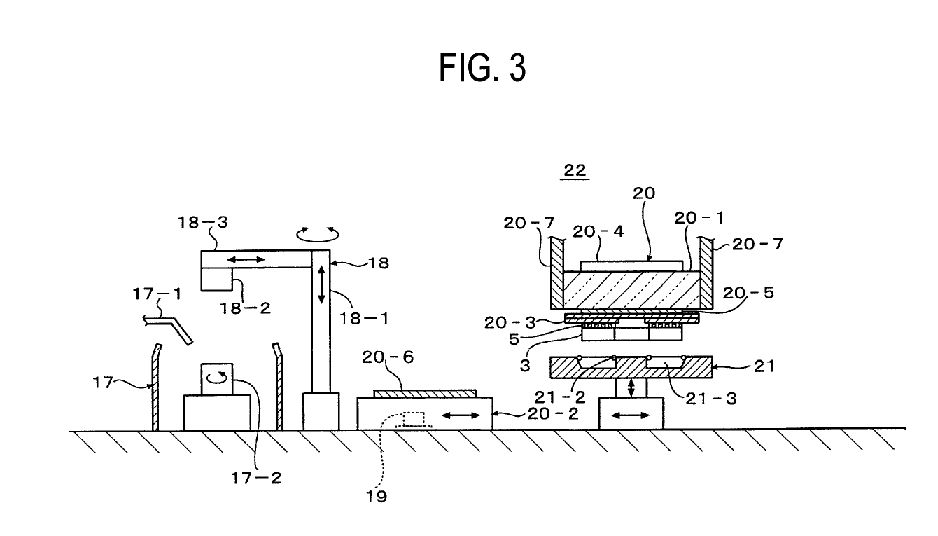

FIG. 3 is a partial cross-sectional view schematically showing another embodiment of a pattern transfer mechanism 22A in a fine structure transfer apparatus of the present invention. In the embodiment, the lower stage section 20-2 and the separating mechanism 21 of the pressurizing mechanism 20 are fixed at a predetermined distance on the upper surface of a platform 31 of a carriage 30. Therefore, the lower stage section 20-2 and the separating mechanism 21 are integrally moved. A carriage 30 moves along a guide rail 33 which is installed on the upper surface of a base 32. The carriage 30 can be driven by a common movement-driving mechanism (not shown) that is well known to those skilled in the art. For example, a combination of a stepping motor and a ball screw may be appropriately selected and used. The aligning mechanism 19 is also installed on the platform 31. In this case, the lower stage section 20-2 is mounted on an X-Y table 34. It is possible to aligning the substrate 3 or the molding die 20-3 by moving the X-Y table 34 in the X-direction and/or the Y-direction on the basis of a detection signal of the aligning mechanism 19.

The state shown in FIG. 3 shows the positional relationship between the lower stage section 20-2 and the separating mechanism 21, when the resin-applied substrate 3 is mounted on the upper surface of the shock-absorbing layer 20-6 of the lower stage section 20-2 of the pressurizing mechanism 20 from the substrate handling mechanism 18 or when the pattern-transferred substrate is separated from the molding die 20-3 of the upper head section 20-1 of the pressurizing mechanism 20 by the separating mechanism 21. Therefore, according to the apparatus of the embodiment, it is possible to simultaneously place and separate substrates. That is, it is possible to separate the pattern-transferred substrate from the molding die 20-3 with the separating mechanism 21 while placing the resin-applied substrate 3 onto the upper surface of the shock-absorbing layer 20-6 of the lower stage section 20-2 of the pressurizing mechanism 20 from the substrate handling mechanism 18.

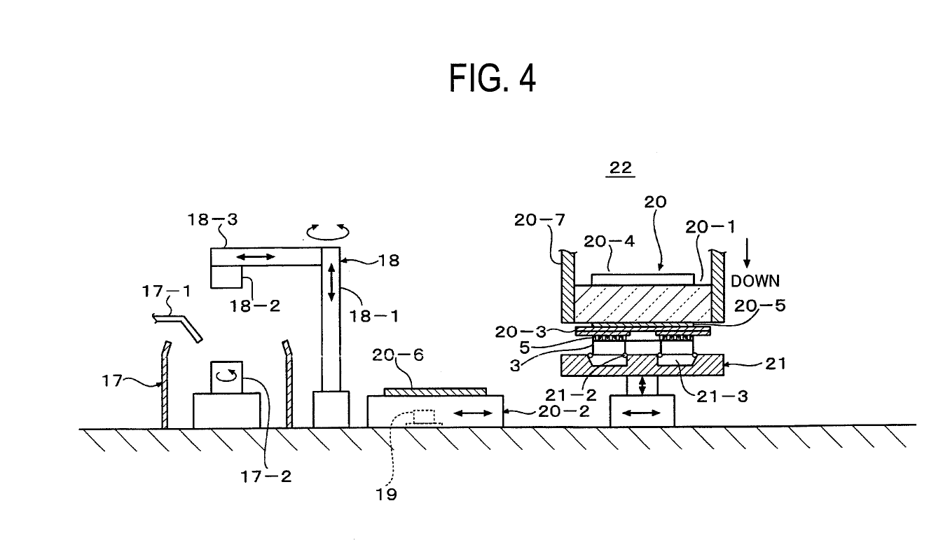

FIG. 4 is a partial cross-sectional view schematically showing another movement state of the pattern transfer mechanism 22A in the fine structure transfer apparatus of the embodiment shown in FIG. 3. The state shown in FIG. 4 shows the positional relationship between the lower stage section 20-2 and the separating mechanism 21 when a substrate is placed on the upper surface of the shock-absorbing layer 20-6 of the lower stage section 20-2 of the pressurizing mechanism 20 and then the substrate is fitted between the upper head section 20-1 and the lower stage section 20-2 as the upper head section 20-1 of the pressurizing mechanism 20 is moved down, or when the pattern-transferred substrate is separated from the molding die 20-3 by the separating mechanism 21 and then the pattern-transferred substrate is carried onto an unloader 24-1 of the substrate unloading mechanism 21 (see FIG. 2). Therefore, according to the apparatus of the embodiment, it may also be possible to simultaneously transfer a pattern onto a substrate and unload a pattern-transferred substrate. That is, it is possible to unload the pattern-transferred substrate to the substrate unloading mechanism 24 from the pattern transfer mechanism 22 (see FIG. 2) by performing pattern transferring by pressurizing the substrate on the lower stage section 20-2 with the molding die 20-3 of the upper head section 20-1, and by carrying the pattern-transferred substrate held by the separating mechanism 21 to the unloader 24-1.

According to the pattern transfer mechanism 22A shown in FIGS. 3 and 4, it is possible to integrally reciprocating the lower stage section 20-2 and the separating mechanism 21 by making the position of the upper head section 20-1 constant. As a result, it is possible to implement a fine structure transfer apparatus with a smaller footprint area, in comparison to the embodiment of FIG. 1 in which the lower stage section 20-2 and the separating mechanism 21 separately reciprocate. An embodiment of forming a fine structure on the disk substrate surface of a hard disk with the fine structure transfer apparatus according to the present invention is described in detail. The present invention is not limited to only the embodiment and may be applied to form a fine structure onto other substrates.

### First Embodiment

A series of works of fine structure transfer using the pattern transfer mechanism 22 in the fine structure transfer apparatus shown in FIG. 1 are described in detail with reference to the drawings.

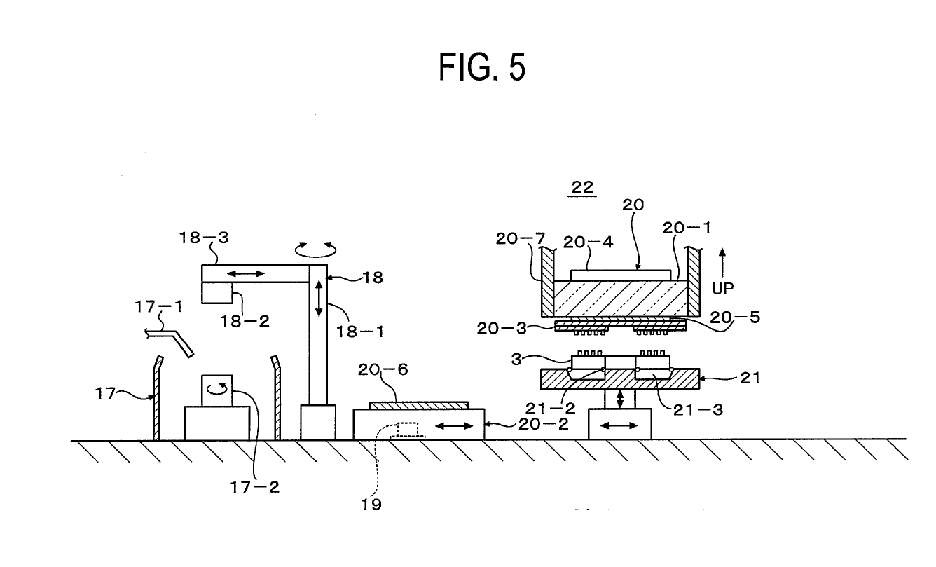

FIG. 5 is a cross-sectional view schematically showing a process of forming a fine structure on the disk substrate surface of a hard disk by the pattern transfer mechanism 22 in the fine structure transfer apparatus of the present invention shown in FIG. 1. In a 2.5 inch disk substrate 3, the inner opening edge of the disk is mechanically held by a disk carrying chuck head 18-2 of the substrate handling mechanism 18, carried to the spindle chuck 17-2 of the resin applying mechanism 17 from the substrate load position 16 (see FIG. 1), and the inner opening edge of the disk is held by the spindle chuck 17-2. Next, while a rotary disk is rotated at 700 rpm, a low-viscosity liquid-state resin material of 1 mL composed of acrylic monomer and polymer components and a radical photoreactive initiator is discharged from resin applying nozzle 17-1, and the rotary disk is rotated at 5000 rpm for 60 seconds, thereby a thin resin film 5 is formed on the surface of the disk substrate 3.

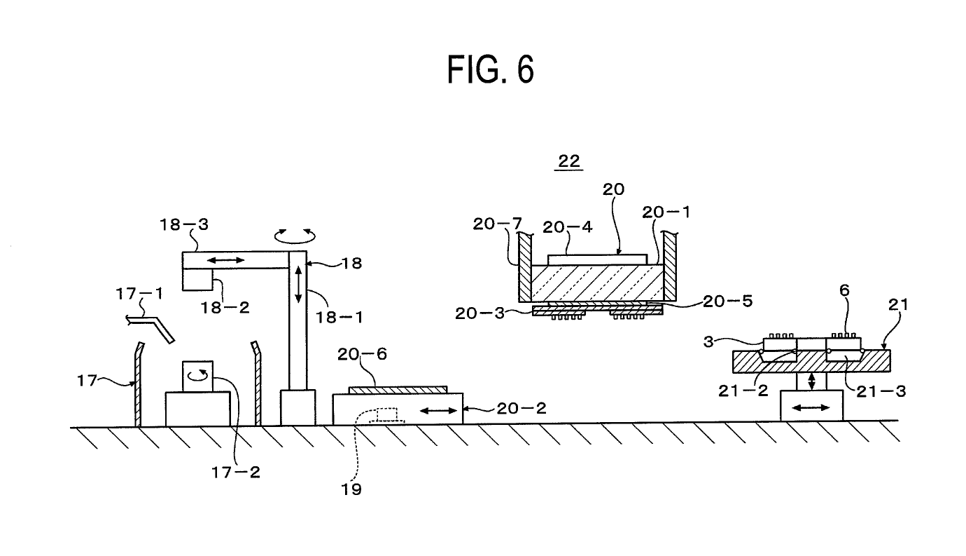

FIG. 6 is a cross-sectional view schematically showing the next process of the process shown in FIG. 5. The disk substrate 3 with the thin resin film 5 is carried again to the aligning mechanism 19 by the disk carrying chuck head 18-2. The lower stage section 20-2 has been moved in advance to the aligning mechanism 19 from the pressurizing mechanism 20. The inside of the lower stage section 20-2 has a structure which is not interfered with the aligning mechanism 19. The lower shock-absorbing layer 20-6 made of silicon and having a thickness of 5 mm is formed on the lower stage section 20-2. Next, alignment marks at the inner edge of the disk substrate and at the lower stage section 20-2 are optically recognized by an alignment CCD camera of the aligning mechanism 19, and then the disk substrate 3 and the lower stage section 20-2 are aligned by an X-Y fine moving mechanism mounted on the lower stage section 20-2.

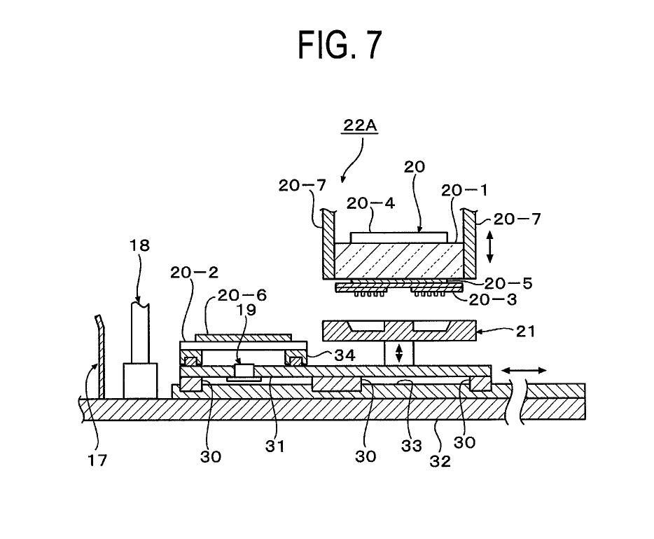

FIG. 7 is a cross-sectional view schematically showing the next process of the process shown in FIG. 6. The disk substrate 3 with the thin resin film 5 is mounted on the lower shock-absorbing layer 20-6 of the lower stage section 20-2, when aligning is finished. Thereafter, for example, the disk substrate is fixed to the lower stage section 20-2 by the absorption to the vacuum. In stead of vacuum absorbing, the substrate 3 may be fixed to the lower stage section 20-2 by a clamping mechanism.

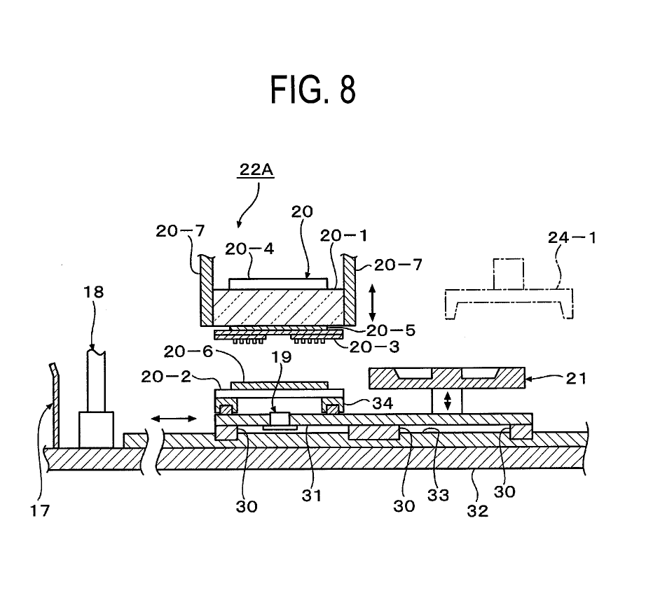

FIG. 8 is a cross-sectional view schematically showing the next process of the process shown in FIG. 7. When the substrate 3 is fixed to the lower stage section 20-2, the lower stage section 20-2 where the disk substrate 3 with the thin resin film is mounted is moved under the upper head section 20-1 where the molding die 20-3 of the pressurizing mechanism 20 is mounted through the upper shock-absorbing layer 20-5 made of silicon having a thickness of 5 mm.

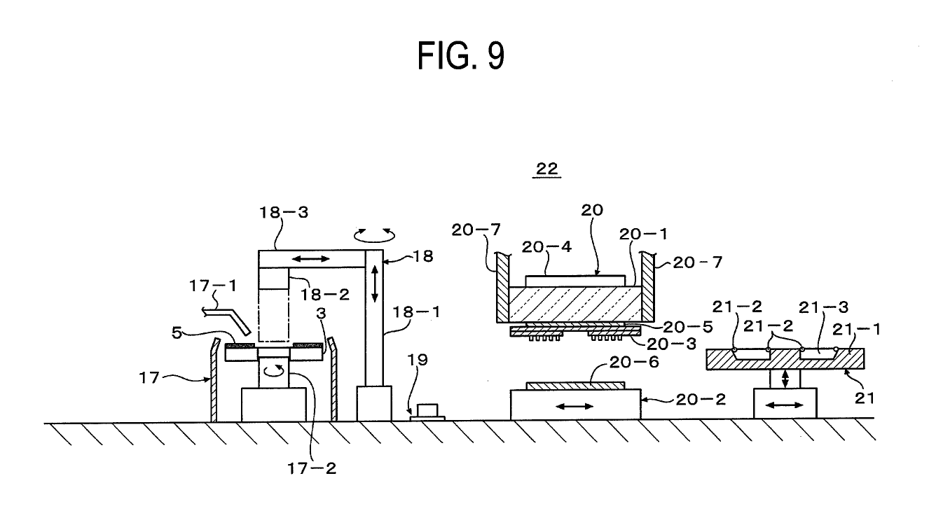

FIG. 9 is a cross-sectional view schematically showing the next process of the process shown in FIG. 8. As the lower stage section 20-2 moves under the upper head section 20-1, the lower stage section 20-2 is moved by the amount of predetermined offset by the X-Y fine moving mechanism and aligned with respect to the molding die 20-3. Then, the upper head section 20-1 is moved down onto the disk substrate 3 with the thin resin film by a ball screw which is controlled by a stepping motor and pressurized by thrust force of 90 N for 10 seconds. And then, the thin resin film is cured by radiating UV rays from an LED UV-light source 20-4 mounted in the upper head section at 60 mW/cm2 for 4 seconds.

The molding die 20-3 used in the embodiment is manufactured by the following method. First, surface treatment was performed on the surface of a synthetic quartz of 90 mm×120 mm×0.7 mm, which is a base, under oxygen plasma 300 W for 1 minute and then the synthetic quartz was brought in close contact by using a silane coupling agent KBM603. Next, cationically polymerizable siloxane-based photo-curable resin was dropped on the base substrate. Next, an original master plate made of Ni and having concentric line patterns having 2.5 inch Ø at pitches of 90 nm on the surface was pressed to the base such that the cationically polymerizable siloxane-based photo-curable resin dropped on the substrate is widened on the surface of the substrate. And then a UV-ray was radiated at luminance of 100 mW/cm² for 480 seconds by an extra high-pressure mercury lamp to cure. Then, the original master plate made of Ni was separated from the cured cationically polymerizable siloxane-based photo-curable resin, thereby manufacturing a replica molding die made of resin, which is used as the molding die 20-3.

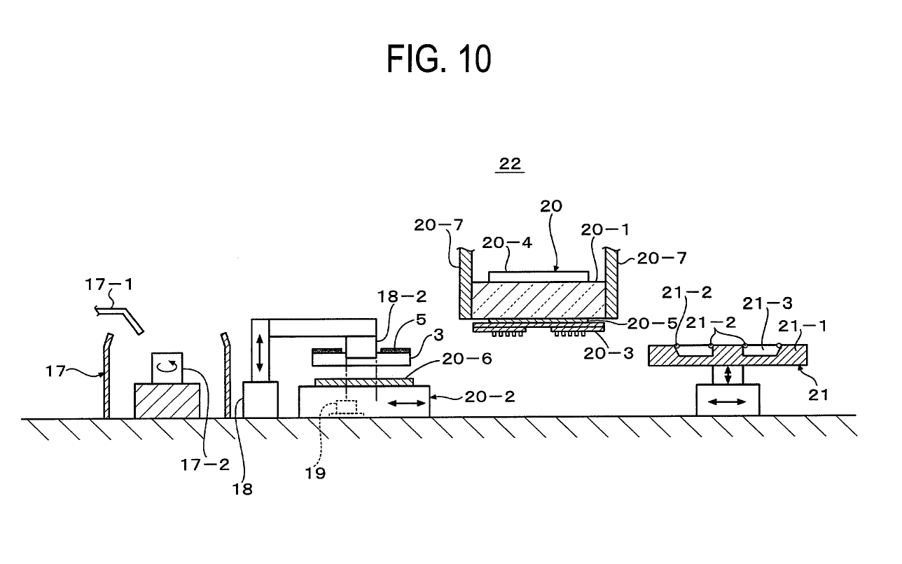

FIG. 10 is a cross-sectional view schematically showing the next process of the process shown in FIG. 9. After the thin resin film is cured, stopping the absorbance of the substrate 3 by the lower stage section 20-2, and then the upper stage section 20-1 is moved up with the disk substrate 3 in close contact with the molding die 20-3.

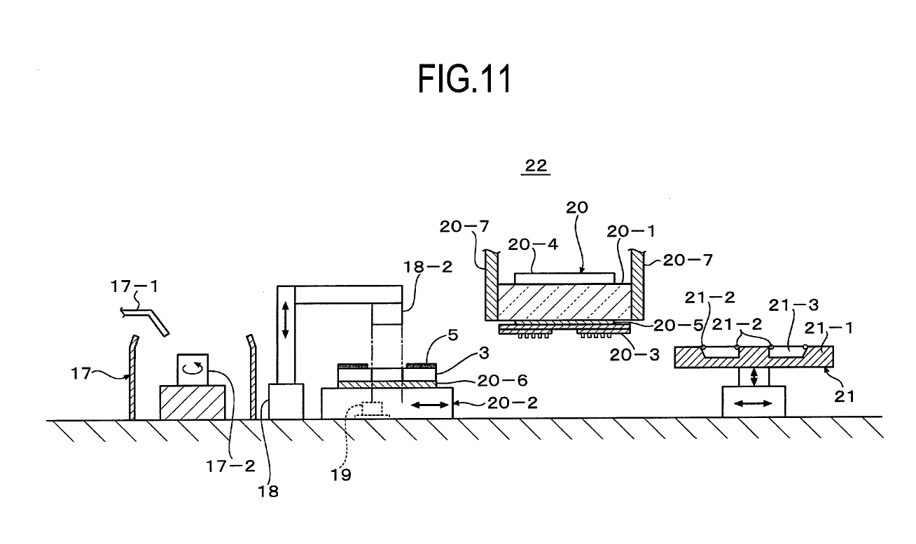

FIG. 11 is a cross-sectional view schematically showing the next process of the process shown in FIG. 10. The lower stage section 20-2 is retracted to the aligning mechanism 19 and the separating chuck 21-1 of the separating mechanism 21 is moved right under the disk substrate 3 that is in close contact with the molding die 20-3 fixed to the upper head section 20-1 of the pressurizing mechanism 20. In the separating chuck 21-1, installing an O-ring 21-2 and an absorbing cavity 21-3 for absorbing is formed for only the edge of the disk substrate 3 is in contact with the separating chuck 21-1.

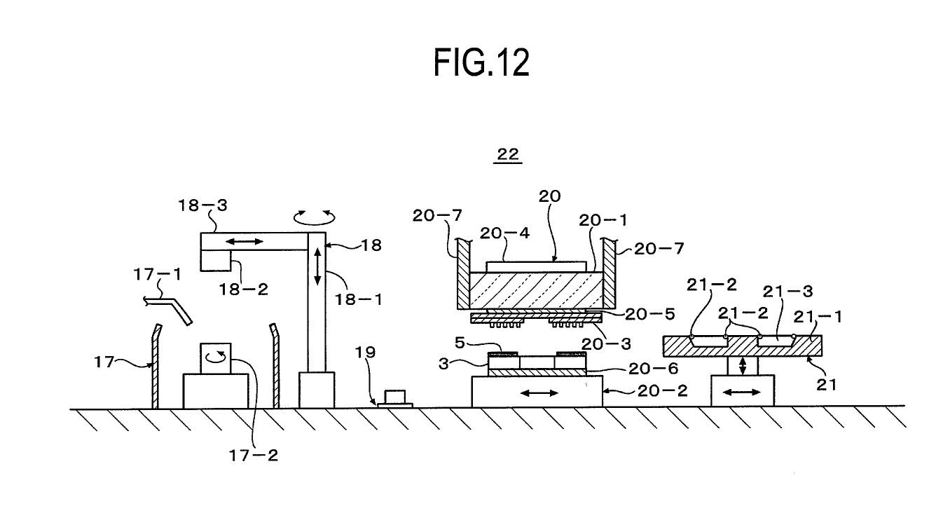

FIG. 12 is a cross-sectional view schematically showing the next process of the process shown in FIG. 11. The upper head section 20-1 of the pressurizing mechanism 20 is moved down to come in contact with the separating chuck 21-1 of the separating mechanism 21, such that it is absorbed to the vacuum to the separating chuck 21-1. Since there is the O-ring 21-4, the vacuum is maintained.

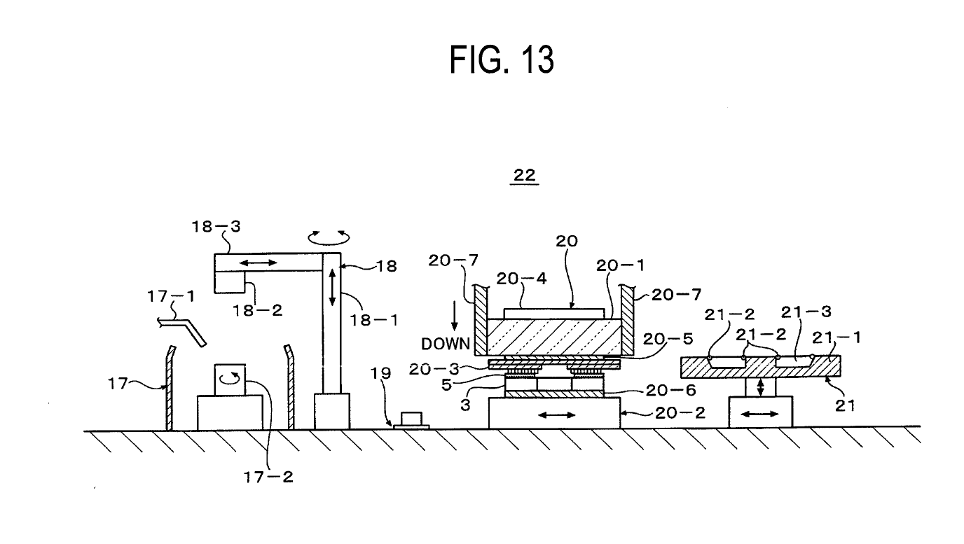

FIG. 13 is a cross-sectional view schematically showing the next process of the process shown in FIG. 12. After the disk substrate 3 is surely absorbed to the vacuum to the separating chuck 21-1, the disk substrate 3 can be separated from the molding die 20-3 by moving up the upper head section 20-1 again.

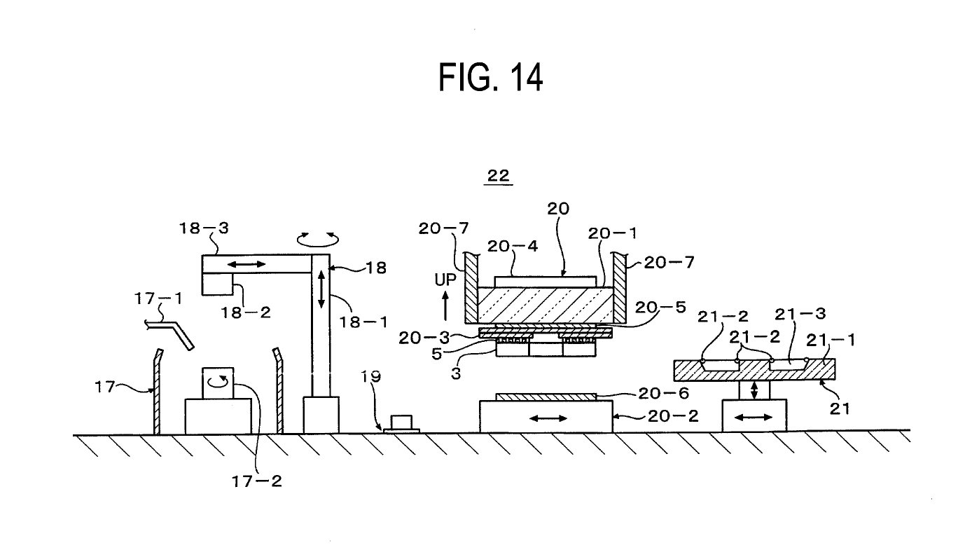

FIG. 14 is a cross-sectional view schematically showing the next process of the process shown in FIG. 13. Holding the disk substrate 3, on which the cured fine resin pattern 6 is formed, the separating chuck 21-1 of the separating mechanism 21 is moved from right under the pressurizing mechanism 20 to a predetermined position of the separating mechanism 21, thereby finishing transferring. Though not shown in the drawings, the pattern-transferred disk substrate 3 held by the separating chuck 21-1 is carried thereafter to the unloader 24-1 (see FIG. 4) of the substrate unloading mechanism 24 (see FIG. 2), for example, thereby finishing the series of work.

According to an embodiment of the present invention, a substrate is carried from the aligning mechanism 19 to the separating mechanism 21 by the lower stage section 20-2 of the pressurizing mechanism 20 and the separating chuck 21-1 of the separating mechanism 21, and an exclusive substrate carrying mechanism is not necessary. As a result, the carrying mechanism spaces between the mechanisms from the aligning mechanism 19 to the substrate unloading mechanism 24 (see FIG. 2) can be removed, thereby reducing the footprint area. Further, the time for attaching/detaching the disk substrate between the mechanisms is reduced, which contributes to improving productivity. Further, since the substrate 3 is brought in close contact with the molding die 20-3 of the upper head section 20-1 of the pressurizing mechanism 20 and it makes possible for the upper stage section 20-2 of the pressurizing mechanism 20 and the separating chuck 21-1 of the separating mechanism 21 to move the lower position of the substrate 3, the substrate 3 can be moved straight and all units can be disposed on a straight line, such that a dead space is not generated and the footprint area is reduced.

The pattern on the lower surface of the molding die 20-3 is damaged and/or worn, in accordance with repeatedly performing the transferring. Therefore, it is necessary to regularly or irregularly replace the molding die to ensure accurate pattern transferring. It may be possible to manually separate the old molding die 20-3 from the upper head section 20-1 of the pressurizing mechanism 20 and replacing the molding die 20-3 with a new molding die after stopping the transferring line, but it reduces operation efficiency and is not preferable.

Therefore, the present invention provides a fine structure transfer apparatus that can automatically replace the molding die 20-3, as another embodiment.

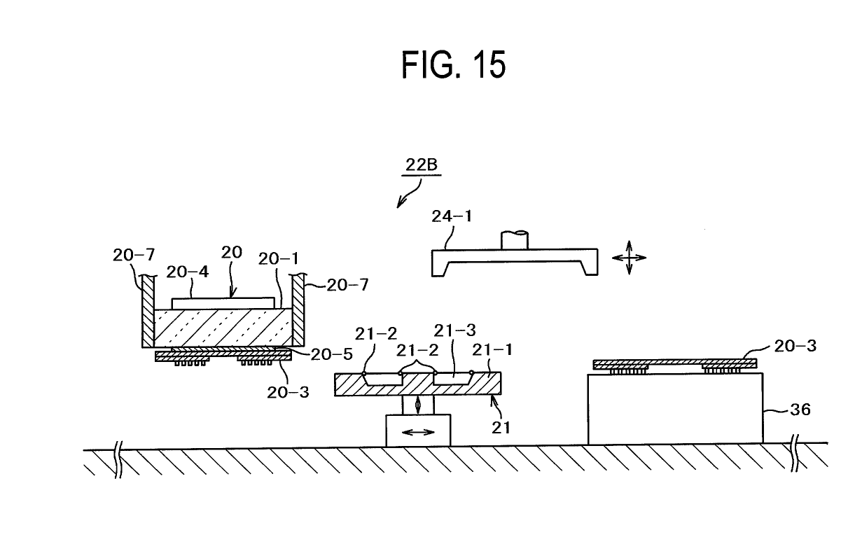

FIG. 15 is a partial cross-sectional view schematically showing an example of a fine structure transfer apparatus 22B provided with an automatic replacement function for the molding die 20-3. The fine structure transfer apparatus 22B shown in FIG. 15 includes a molding die stocker 36. The molding die stocker 36 stocks one sheet or more of new molding dies, or preferably plural sheets of molding dies. The new molding die received in the molding die stocker 36 and the old molding die that is damaged or worn (described in detail below) are preferably handled by the unloader 24-1 (see FIG. 4) of the substrate unloading mechanism 24 (see FIG. 2). However, an exclusive handling mechanism for replacing a molding die may be installed.

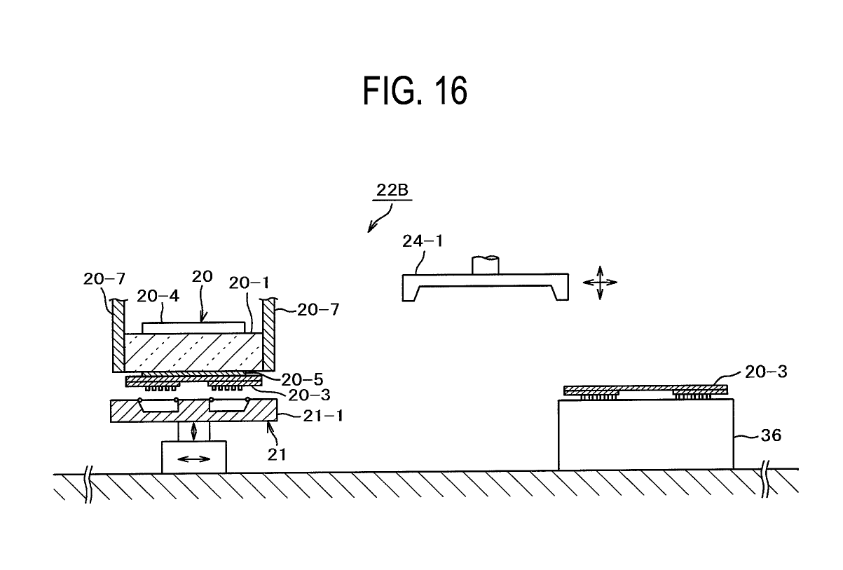

Hereinafter, the order of the work of replacing a molding die is described with reference to the drawings. FIG. 16 is a cross-sectional view schematically showing the first step of the work for replacing a molding die. First, the separating mechanism 21 is moved right under the pressurizing mechanism 20 to be opposite the molding die 20-3.

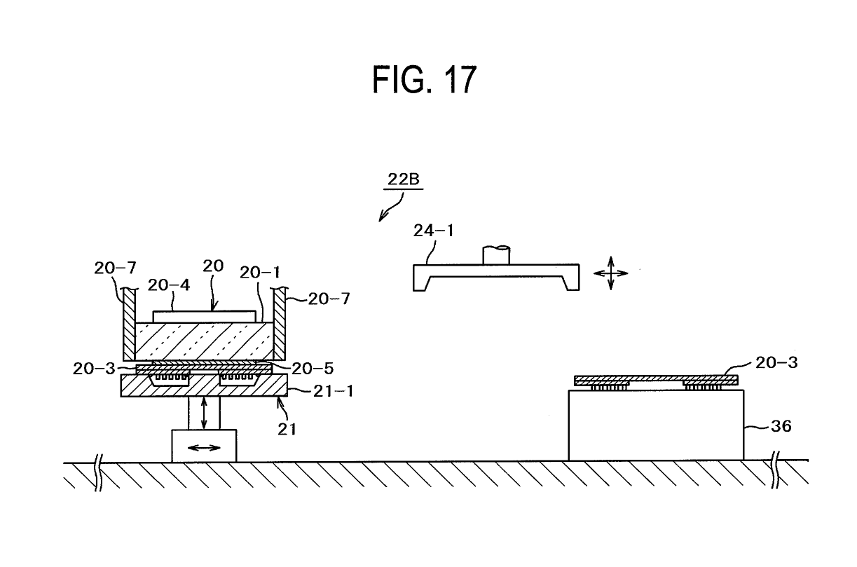

FIG. 17 is a cross-sectional view schematically showing the second step of the work for replacing a molding die. The upper head section 21-1 of the separating mechanism 21 is moved up to come in contact with the lower surface of the molding die 20-3. For example, the molding die 20-3 is held by the pressurizing mechanism 20 by being absorbed to the vacuum to the lower surface of the upper head section 20-1 of the pressurizing mechanism 20. Therefore, when absorption to the vacuum is stopped, the old molding die 20-3 can be simply placed onto the upper surface of the upper head section 21-1 of the separating mechanism 21 from the lower surface of the upper head section 20-1 of the pressurizing mechanism 20. The old molding die 20-3 placed on the upper surface of the upper head section 21-1 of the separating mechanism 21 may be absorbed to the vacuum to the upper surface of the upper head section 21-1 of the separating mechanism 21, if necessary.

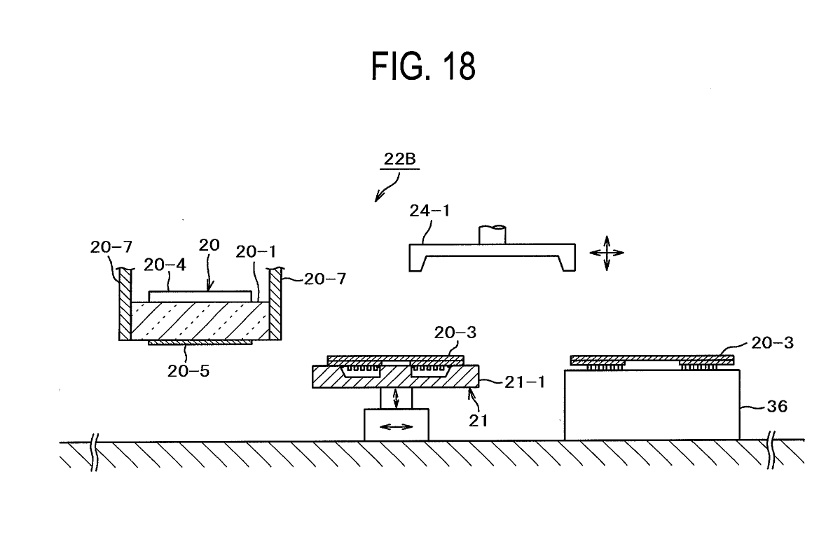

FIG. 18 is a cross-sectional view schematically showing the third step of the work for replacing a molding die. When the old molding die 20-3 is placed on the upper surface of the upper head section 21-1 of the separating mechanism 21 from the lower surface of the upper head section 20-1 of the pressurizing mechanism 20, the upper head section 21-1 of the separating mechanism 21 is moved down and the separating mechanism 21 is moved to the right. Therefore, the old molding die 20-3 is moved to the right, on the upper surface of the upper head section 21-1 of the separating mechanism 21.

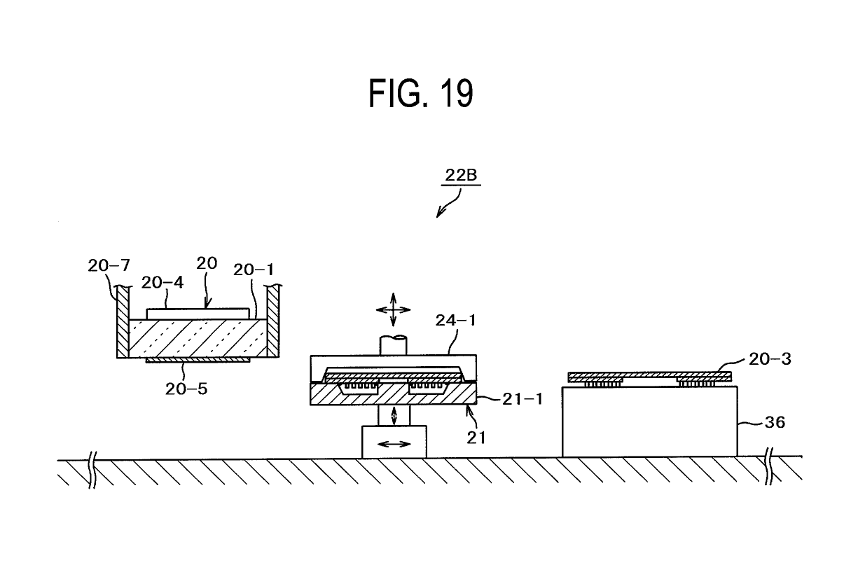

FIG. 19 is a cross-sectional view schematically showing the fourth step of the work for replacing a molding die. The unloader 24-1 chucks the old molding die 20-3 placed on the upper surface of the upper head section 21-1 of the separating mechanism 21 by the absorption to the vacuum. When the separating mechanism 21 absorbs the old molding die 20-3 to the vacuum, it needs to stop absorption to the vacuum.

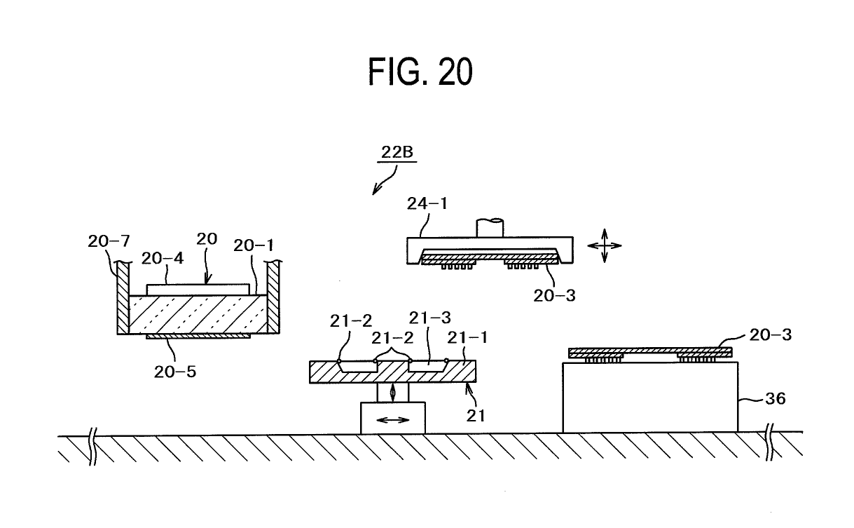

FIG. 20 is a cross-sectional view schematically showing the fifth step of the work for replacing a molding die. When the unloader 24-1 chucks the old molding die 20-3 placed on the upper surface of the upper head section 21-1 of the separating mechanism 21 by the absorption to the vacuum, the unloader 24-1 carries the old molding die 20-3 to an appropriate discarding place (not shown), the absorption to the vacuum is stopped at the place, and the old molding die 20-3 is discarded. The molding die stocker 36 may be used for the abandonment place of the old molding die 20-3. For example, it is possible to use the molding die stocker 36 as a container for stocking a new molding die and a container for discarding an old molding die, by setting a compartment for receiving a new molding die and a compartment for receiving an old molding die, in the molding die stocker 36.

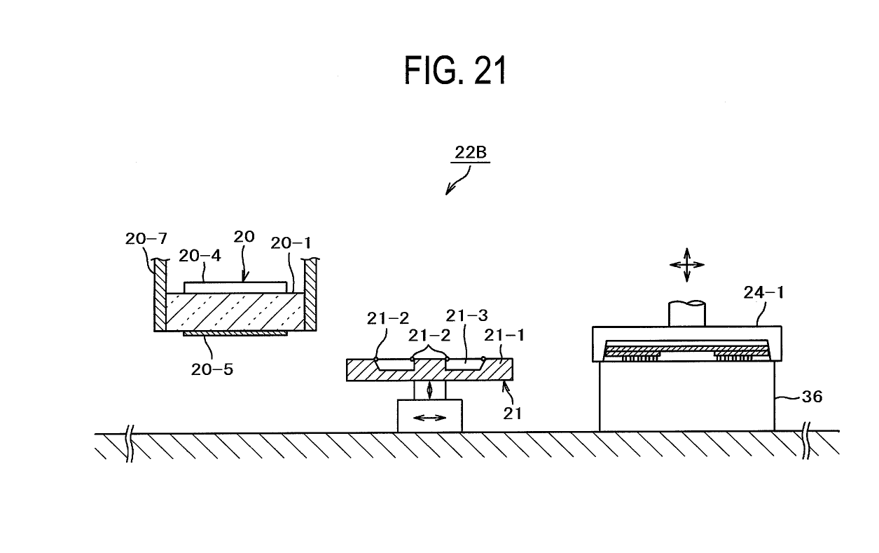

FIG. 21 is a cross-sectional view schematically showing the sixth step of the work for replacing a molding die. After the unloader 24-1 carries the old molding die 20-3 to an appropriate discarding place, the unloader 24-1 moves to the molding die stocker 36 and chucks and holds a new molding die 20-3 by the absorption to the vacuum.

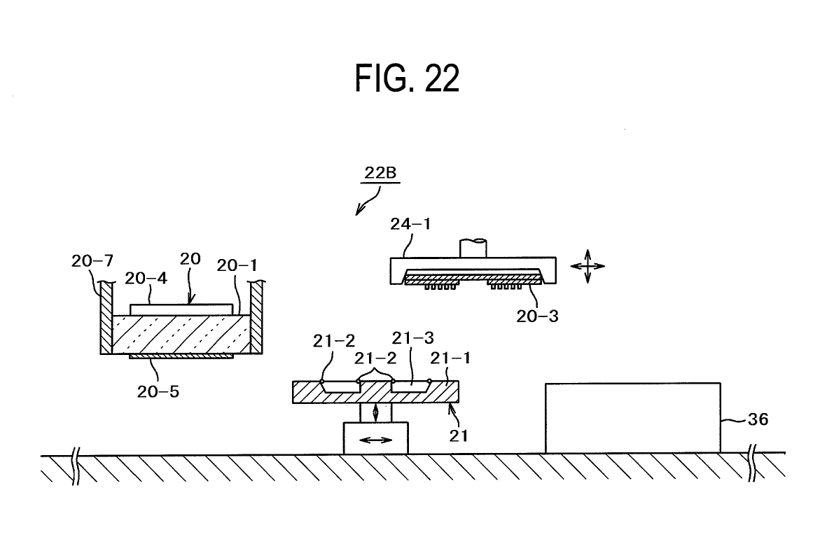

FIG. 22 is a cross-sectional view schematically showing the seventh step of the work for replacing a molding die. After taking out the new molding die 20-3 from the molding die stocker 36, the unloader 24-1 moves to the upper head 21-1 of the separating mechanism 21. Thereafter, in accordance with the inverse order of the order of the work for replacing a molding die shown in FIGS. 19 to 16, the new molding die 20-3 is absorbed to the vacuum to the lower surface of the upper head section 20-1 of the pressurizing mechanism 20, thereby finishing the work of replacing a molding die.

The work of replacing a molding die shown in FIGS. 16 to 22 may also be applied to the fine structure transfer apparatus 22A of the embodiment shown in FIG. 4.

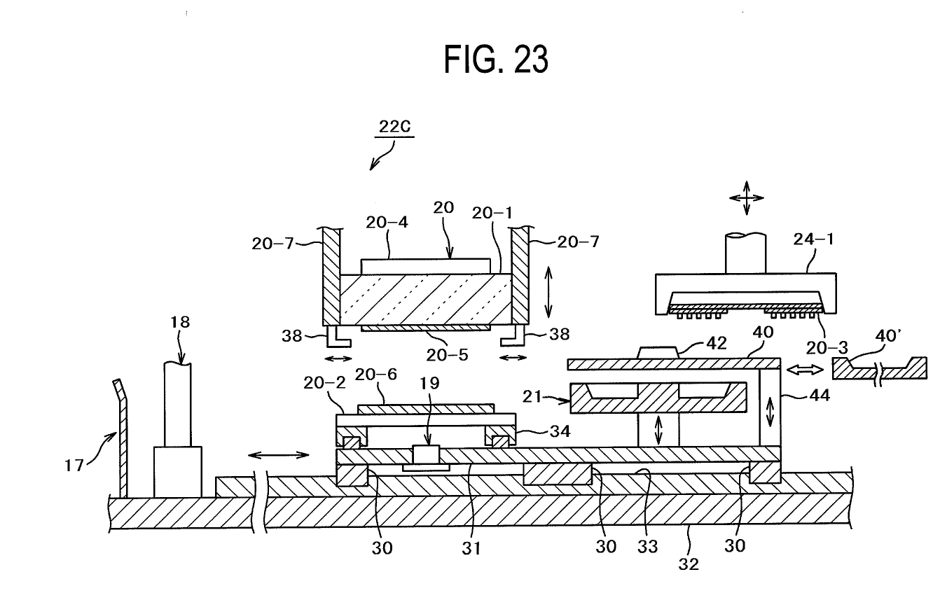

FIG. 23 is a partial cross-sectional view schematically showing another embodiment of a fine structure transfer apparatus 22C of the present invention. In the fine structure transfer apparatus 22C of the present embodiment, a clamping mechanism 38 with a variable opening diameter is used to hold the molding die 20-3, since it is held on the lower surface of the upper head section 20-1 of the pressurizing mechanism 20. The fine structure transfer apparatus 22C of the present embodiment includes a molding die handling plate 40 to replace old and new molding dies 20-3. A conical protrusion 42 having a trapezoidal cross-section is installed at the substantially center portion of the molding die handling plate 40. The diameter of the uppermost portion of the conical protrusion 42 having a trapezoidal cross-section is smaller than the diameter of the opening at the center portion of the molding die 20-3 and the diameter of the lowermost portion of the conical protrusion 42 having a trapezoidal cross-section is larger than the diameter of the opening at the center portion of the molding die 20-3. Therefore, the molding die 20-3 is fitted at the middle portion of the outer surface of the conical protrusion 42 having a trapezoidal cross-section. The molding handling plate 40 is held by a vertically movable or rotatable column 44. The column 44 is installed on the platform 31. The order of work for replacing old and new molding dies in the fine structure transfer apparatus 22C of the present embodiment is described. As shown in FIG. 15, the unloader 24-1 receives a new molding die 20-3 from the molding die stocker and carries it.

The molding die handling plate 40 of FIG. 23 has the conical protrusion 42 having a trapezoidal cross-section at the center portion, but it can receive a molding die without using the protrusion 42. As in the molding die handling plate 40, a recession is installed at one-step under the upper surface in a size slightly larger than the outer mold of the molding die. An inclined surface may be formed between the upper surface and the bottom of the recession to determine the position of the outer mold of the molding die on the inclined surface.

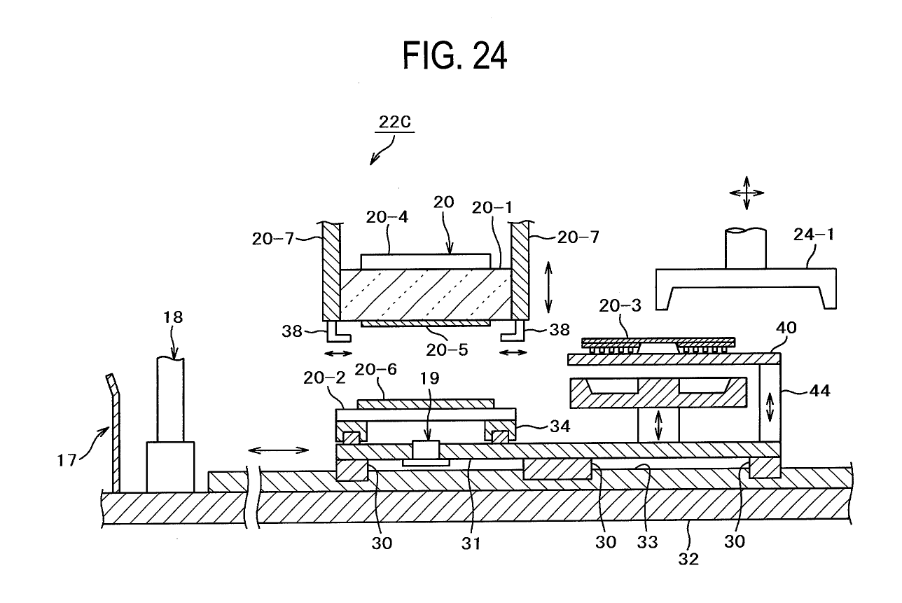

As shown in FIG. 24, the unloader 24-1 inserts the new molding die 20-3 into the conical trapezoid 42 of the molding die handling plate 40, and then retracts.

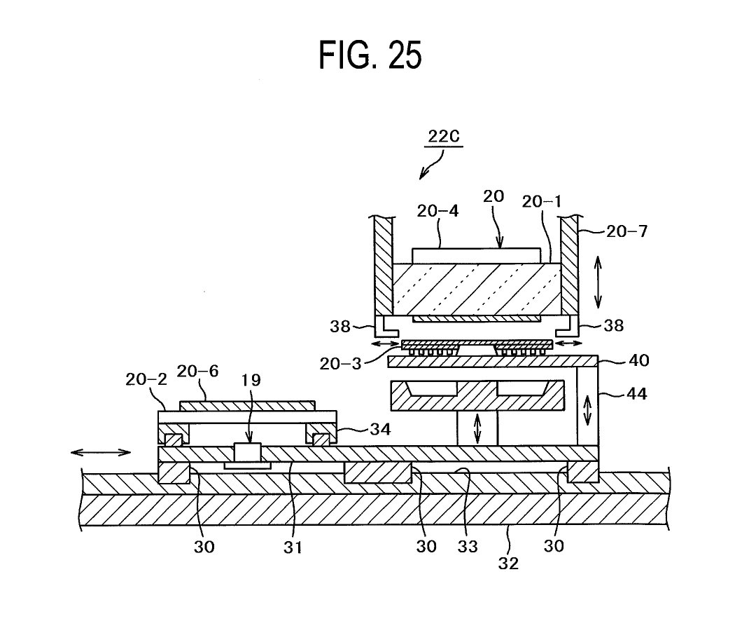

As shown in FIG. 25, the platform 31 is moved to the left by the carriage and the molding die 20-3 is carried and stopped right under the upper head section 20-1 of the pressurizing mechanism 20.

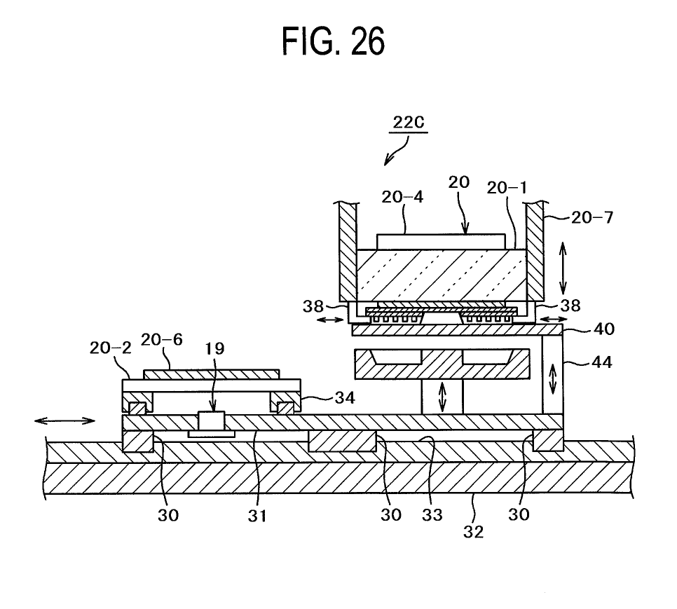

As shown in FIG. 26, as the column 44 of the molding die handling plate 40 is moved up or the pressurizing mechanism 20 is moved down, the new molding die 20-3 fitted at the conical protrusion 42 having a trapezoidal cross-section of the molding die handling plate 40 is brought in close contact with the shock-absorbing layer 20-5 under the upper head section 20-1 of the pressurizing mechanism 20, and then the opening diameter of the clamping mechanism 38 is reduced, thereby surely holding the molding die 20-3 to the clamping mechanism 38. Further, when the new molding die 20-3 is installed at the pressurizing mechanism, the column 44 moves down. The molding die handling plate 40 retracts from the upper surface of the separating mechanism 21 to be placed at a position where the molding die handling plate 40 does not interfere with transferring.

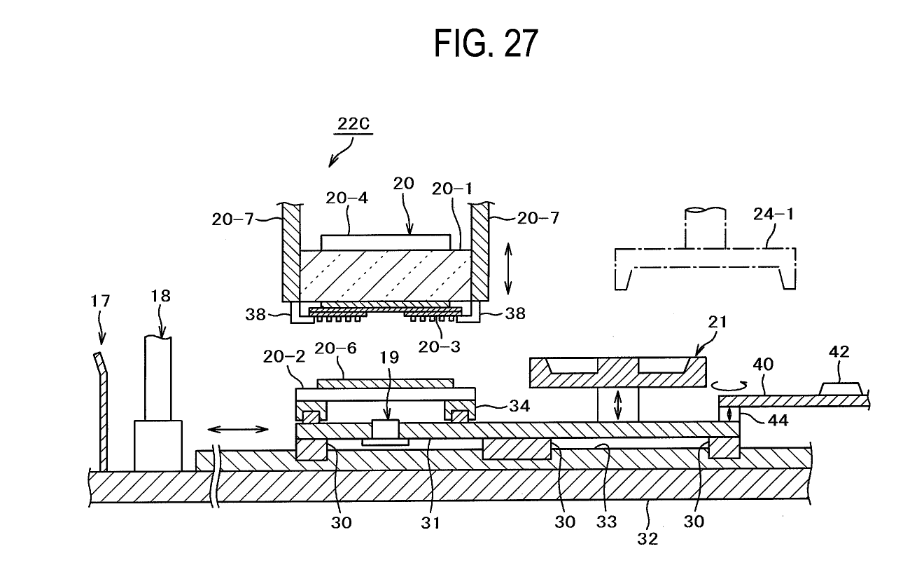

Further, as shown in FIG. 27, when the new molding die 20-3 is installed at the pressurizing mechanism 20, the column 44 rotates and retracts the molding die handling plate 40 from the upper surface of the separating mechanism 21, and the column 44 may move down to be placed at a position where the molding die handling plate 40 does not interfere with transferring.

In the fine structure transfer apparatus 22C, separating the old molding die 20-3 from the pressurizing mechanism 20 may be performed in the inverse order of the order described above.

### INDUSTRIAL APPLICABILITY

Although embodiments of a fine structure transfer apparatus of the present invention were described above, the present invention is not limited the embodiments and may be modified in various ways. For example, in order to prevent bubbles from being contained between the non-cured resin-applied disk 3 and the molding die 20-3, the upper surface of the lower stage section 20-2 may be curved or the entire fine structure transfer apparatus may be received in an air-stripping room.

### REFERENCE SIGN LIST

3: Substrate
5: Thin resin film
6: Curable resin fine pattern
16: Substrate load position
17: Applying mechanism
17-1: Resin applying nozzle
17-2: Spindle chuck
18: Substrate handling mechanism
18-1: Vertical handling arm
18-2: Chuck head
18-3: Horizontal handling arm
19: Aligning mechanism
20: Pressurizing mechanism
20-1: Upper head section
20-2: Lower stage section
20-3: Molding die
20-4: UV-radiating mechanism
20-5: Shock-absorbing layer
20-6: Shock-absorbing layer
20-7: Support arm
21: Separating mechanism
21-1: Separating chuck
21-2: O-ring
21-3: Absorbing cavity
22: Pattern transfer mechanism
23: Substrate loading mechanism
24: Substrate unloading mechanism
25: Control mechanism
30: Carriage
31: Platform
32: Base
33: Guide rail
34: X-Y table
36: Molding die stocker
38: Clamping mechanism
40: Molding die handling plate
42: Conical protrusion having trapezoidal cross-section
44: Column

1. A fine structure transfer apparatus that forms a thin resin film on a substrate, cures the thin resin film with a molding die, which has a fine pattern formed thereon, pressed onto the thin resin film, and forms a fine pattern on the substrate, the fine structure transfer apparatus comprising:
a pattern transfer mechanism including a resin applying mechanism, a substrate handling mechanism, an aligning mechanism, a pressurizing mechanism, and a separating mechanism,
wherein the pressurizing mechanism is including an upper head section and a lower stage section, a molding die having a fine pattern is fixed to a lower surface of the upper head section, the lower stage section retracts from a lower portion of the substrate with the substrate in close contact with the molding die, after pressurizing and transferring and then the separating mechanism is moved under the substrate and the substrate that is in close contact with the molding die is separated.

2. The fine structure transfer apparatus according to claim 1, wherein the upper head section of the pressurizing mechanism is supported to an elevating mechanism, the lower stage section of the pressurizing mechanism and the separating mechanism are installed on an upper surface of a platform of a carriage placed on a guide rail, the aligning mechanism is installed under the lower stage section installed on the platform, and the carriage is reciprocated on the guide rail by a movement-driving mechanism, such that the lower stage section and the separating mechanism alternately and integrally reciprocate to be opposite to the upper head section of the pressurizing mechanism, around a position of the upper head section of the pressurizing mechanism.

3. The fine structure transfer apparatus according to claim 1, further comprising:
a substrate loading mechanism for loading a substrate on the pattern transfer mechanism and a substrate unloading mechanism for unloading the substrate with a pattern transferred by the pattern transfer mechanism,
wherein the substrate loading mechanism, the pattern transfer mechanism, and the substrate unloading mechanism are arranged such that a direction in which the substrate is moved by the substrate loading mechanism and the substrate unloading mechanism and a movement direction of the substrate in the pattern transfer mechanism go straight.

4. The fine structure transfer apparatus according to claim 3, wherein two or more pairs of pattern transfer mechanisms are provided between a pair of substrate loading mechanism and substrate unloading mechanism.

5. The fine structure transfer apparatus according to claim 1, wherein the pressurizing mechanism has an exposing mechanism that radiates light to the substrate that has been pressurized.

6. The fine structure transfer apparatus according to claim 1, wherein the resin applying mechanism, the substrate handling mechanism, the aligning mechanism, the pressurizing mechanism, and the separating mechanism of the pattern transfer mechanism are arranged in a straight line.

7. The fine structure transfer apparatus according to claim 1, wherein the pattern transfer mechanism is equipped with a control mechanism that simultaneously perform any one process of resin applying, substrate handling, aligning, pressurizing, and separating on at least two substrates, in any one of the resin applying mechanism, the substrate handling mechanism, the aligning mechanism, the pressurizing mechanism, and the separating mechanism.

8. The fine structure transfer apparatus according to claim 1, wherein the molding die is detachably held to the pressurizing mechanism by being absorbed to the vacuum to the lower surface of the upper head section of the pressurizing mechanism.

9. The fine structure transfer apparatus according to claim 1, wherein the molding die is detachably held to the pressurizing mechanism by a clamping mechanism having a variable opening diameter on the lower surface of the upper head section of the pressurizing mechanism.

10. The fine structure transfer apparatus according to claim 9, further comprising:
a molding die handling plate having a conical protrusion having a trapezoidal cross-section at a substantially center portion and fixed to a vertically movable and rotatable column, or
a molding die handling plate having a recession inside an outer mold fixed to the vertically movable column.

11. The fine structure transfer apparatus according to claim 10, further comprising:
a molding die stocker.

12. The fine structure transfer apparatus according to claim 11, wherein the substrate unloading mechanism includes an unloader, the unloader carries an old molding die placed on an upper surface of the separating mechanism by being separated from the pressurizing mechanism, receives a new molding die from the molding die stocker, and places the new molding die onto the upper surface of the separating mechanism.

13. The fine structure transfer apparatus according to claim 11, wherein the substrate unloading mechanism includes an unloader, the unloader carries an old molding die inserted in a conical protrusion having a trapezoidal cross-section of the molding die handling plate by being separated from the pressurizing mechanism or an old molding die placed on the recession of the molding die handling plate by being separated from the pressurizing mechanism, receives a new molding die from a molding die stocker, and inserts the new molding die into the conical protrusion having a trapezoidal cross-section of the molding die handling plate or disposes the new molding die into the recession of the molding die handling plate.

14. A fine structure transfer method that forms a thin resin film on a substrate, cures the thin resin film with a molding die, which has a fine pattern formed thereon, pressed onto the thin resin film, and forms a fine pattern on the substrate, the method comprising:
using a pattern transfer mechanism including a resin applying mechanism, a substrate handling mechanism, an aligning mechanism, a pressurizing mechanism, and a separating mechanism,
wherein the pressurizing mechanism is including an upper head section and a lower stage section, a molding die having a fine pattern is fixed to a lower surface of the upper head section, the lower stage section retracts from a lower portion of the substrate with the substrate in close contact with the molding die, after pressurizing and transferring, and then the separating mechanism is moved under the substrate and the substrate that is in close contact with the molding die is separated.

15. The fine structure transfer method according to claim 14, wherein the upper head section of the pressurizing mechanism is supported to an elevating mechanism, the lower stage section of the pressurizing mechanism and the separating mechanism are installed on an upper surface of a platform of a carriage placed on a guide rail, the aligning mechanism is installed under a lower stage section installed on the platform, and the carriage is reciprocated on the guide rail by a movement-driving mechanism, such that the lower stage section and the separating mechanism alternately and integrally reciprocate to be opposite to the upper head section of the pressurizing mechanism, around a position of the upper head section of the pressurizing mechanism.
